(19) United States
(12) Patent Application Publication
(10) Pub. No.: US 2012/0239663 A1
(43) Pub. Date: Sep. 20, 2012

(54) PERSPECTIVE-BASED CONTENT FILTERING

(75) Inventors: Yoav M. Tzruya, Even Yehuda (IL); Mark E. Kahn, New York, NY (US)

(73) Assignee: CITYPULSE LTD., Jerusalem (IL)

(21) Appl. No.: 13/419,687

(22) Filed: Mar. 14, 2012

Related U.S. Application Data
(60) Provisional application No. 61/454,202, filed on Mar. 18, 2011.

(51) Int. Cl. G06F 17/30

(52) U.S. Cl. 707/741; 707/E17.059

(57) ABSTRACT

An automated system and a method are described for providing a personalized set and stream of content from the system to a user of an end-user device. The content may include multiple items of various sorts and media types, including textual items, video, audio and/or proprietary or composite content elements that originate from various sources. The content may be consumed by the end-user or by multiple applications on behalf of the end-user, whether on an end-user device or on a server for further processing. The system filters the content made available to end-users in a manner unique to each end-user. Filtering is based on characteristics associated with the content element, the originating source and author, and unique preferences relevant to the end-user. Filtering can be done in real time or be based on prior processing.

### CROSS-REFERENCE TO RELATED APPLICATIONS

This application claims priority to U.S. Provisional Patent Application No. 61/454,202, entitled “Perspective-Based Content Filtering” and filed on Mar. 18, 2011, the entirety of which is incorporated by reference herein.

### BACKGROUND OF THE INVENTION

1. Field of the Invention

The invention generally relates to filtering content for a user in a highly-personalized fashion. In particular, the invention relates to a system and a method that identifies for each user in the system a set of peer groups the user belongs to, and further identifies for each content item a set of users the content item belongs to. In addition, for each user context (e.g., a specific user interest or query), a set of personalized perspectives that map to specific peer groups are identified and content is shown that pertains only to users who are part of the peer groups associated with the personalized perspectives. The method enables users to be presented with content that they find more relevant and credible.

2. Background

The Internet includes more than one trillion URLs and more than 110 million unique web sites. In addition, a great deal of user-generated content, particularly various types of short-form or micro-content elements (such as brief videos on YouTube®, Tweets on Twitter®, status updates and wall posts on Facebook®) and the automatic generation of these by various applications overwhelm users with a wealth of information. This wealth of information, together with the systems and methods used to create, capture and manage it, also finds its way into the enterprise knowledge bases, requiring the enterprise/corporate end-user to sift through the data in order to find relevant information in an efficient and cost-effective manner.

Both end-users and persons skilled in the art are familiar with various methods that allow them to sift through this enormous amount of information. Generally, users consume content through two different channels—either from information sources pre-selected by themselves or by “authoritative third parties” or by using search engines to gain access to content that is presented in manner meant to instill a higher sense of relevancy for the user's context. Examples of the former channel include news sites (e.g., CNN.com), which the user may visit on an ongoing basis in order to consume their information, which the user perceives as credible. Examples of the latter channel might include services such as a Web search engine (e.g., Google®) or Twitter. In addition, from a behavioral perspective, one can divide information-sorting methods that various users employ into compensatory methods (comparing the utility of one content element with another and deciding which to use) and satisficing methods, which help to cut quickly through the wealth of information based on a limited set of criteria (typically a single criterion) at any point in the decision process. Various studies have been conducted on this subject and its application to online search behavior.

The observation of pre-selected information sources brings various issues to mind. For example, such issues may include: who made the selection, on which parameters was the selection based, who is behind the content (both general legal entities and individual contributors), how biased is the content (for commercial or other reasons), how relevant is the content to the user, on what parameters is relevancy defined, how current the information is, and so on.

Search engines suffer from other issues. These issues include, for example, cutting out relevant information in order to narrow down results, the inability to establish credibility easily and relevancy for a specific ranked item and explaining that to the user without the need for exhausting and time-consuming effort, the ability to cover all relevant information sources, personalizing results for a specific user, disambiguating a user's context, and so on.

In particular, when it comes to personalizing results, various forms of statistically-based methods have been used and tested with limited success (both in terms of relevancy and quality/credibility). In general, the statistical methods used to personalize content are based on matching measured characteristics of the user either with measured characteristics of other users to form recommendations or ranking of content elements, or with measured characteristics of content elements. The former method, which is typically referred to as collaborative filtering, is based on the assumption that those who agreed in the past will usually do so again in the future. Such collaborative filtering can be based on search history, click-stream (on results or ads), browsing history, user content (e.g., emails, instant messaging, chats), or other general measurable activities. Various methods are described, for example, in U.S. Pat. No. 6,526,440 and U.S. Patent Application Publication Nos. 2007/0143345, 2006/0212423, 2006/0206476, 2006/0122979 and 2004/0199498.

However, since such statistical methods suffer from both anonymizing the results (i.e., they average user behavior in order to improve relevancy and prediction value) and presenting a process that is hard for the ordinary user to understand (i.e., explaining why the system is showing me this specific result, and how this specific result is more relevant to me than other results), such methods require a binary decision by the user as to whether to trust the opaque process of content filtering. Moreover, such statistical methods tend to provide relevant results only when the connection between past and future needs is clear and the users' various needs are interdependent. One example in which these conditions are not satisfied involves attempting to provide a restaurant recommendation to a user based on restaurants liked by other people who share a similar taste in movies. Obviously, this does not make sense.

In our everyday lives, for each of our needs, we explicitly or implicitly form an advisory group that we consult to give us the best result for each need. For example, a person may ask his friends for advice when he wants to go to a pub, but may rely on the local newspaper's art critic when it comes to choosing a gallery to visit over the weekend.

What is needed, then, are systems and methods that operate to improve both the relevancy of content filtering processes and the ability to establish a level of credibility with the user regarding filtered content, and that operate to explain the results and the process behind them to the user in an efficient and cost-effective manner.

### BRIEF SUMMARY OF THE INVENTION

The purpose of this Summary is to introduce a selection of concepts in a simplified form that are described further in the Detailed Description below. This Summary is not intended to identify key or essential features of the subject matter under discussion, nor is it intended to be used to limit its scope.

An automated system and method is described herein for filtering content for a user given a specific user context, based on user characteristics and preferences for the specific context, and characteristics of users associated with the content. The automated system and method performs a number of functions including identifying a user context (for example, a user query for a search engine or an area of interest defined by the user), identifying perspectives (specific characteristics of users) from which the user would be interested in receiving associated content, filtering content based on these perspectives, and making the content available to the user through various media channels. The content may include textual, graphical, audio or video information, or other forms of content, whether of human or automatic origin.

Also described herein are computer program products, each of which comprises a computer-readable medium with computer program logic recorded thereon. For example, a first computer program product may have a first computer program recorded thereon for enabling a processor to identify perspectives relevant to a specific user's context, a second computer program product may have a second computer program recorded thereon for enabling a processor to identify users associated with content items, and a third computer program product may have a third computer program logic recorded thereon for enabling a processor to identify a group of users with such perspectives. When executed, the first computer program, the second computer program and the third computer program may operate together in an integrated fashion.

Other features and advantages of the invention, as well as the structure and operation of various forms of the invention, are described in detail below with reference to the accompanying sketches. It should be noted that the invention is not limited to the specific forms described here. The forms are presented here for illustrative purposes only. Additional forms will be apparent to persons with the relevant skills based on the statements contained here.

### BRIEF DESCRIPTION OF THE DRAWINGS

The accompanying drawings, which are incorporated herein and form part of the specification, illustrate the invention and, together with the description, further serve to explain the principles of the invention and to enable a person with the relevant skills to make and use the invention.

FIG. 1 is a high-level block diagram of a system that performs a method for perspective-based content filtering for a user, according to a user context.

FIG. 2 is a high-level block diagram of a set of logical components that enable perspective-based content filtering for a user according to a user context.

FIG. 3 depicts a flowchart of a method used to filter content for a user, based on perspectives, according to a user context.

FIG. 4 is a block diagram of an example computer system that may be used to implement various aspects of the invention.

The features and advantages of this invention will become more apparent from the detailed description given below when taken in conjunction with the drawings, in which similar reference characters identify corresponding elements throughout. In the drawings, similar reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Overview

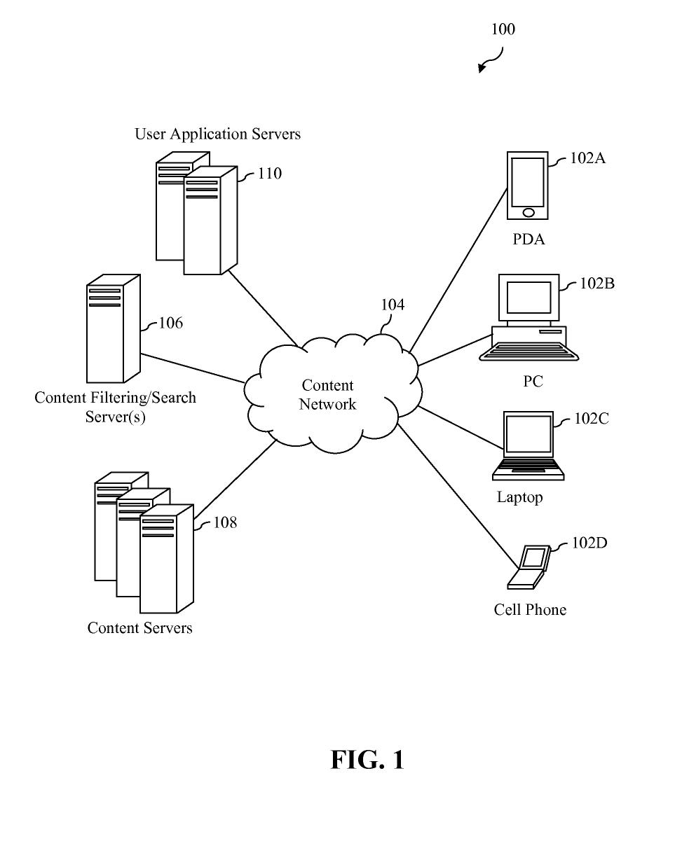

FIG. 1 depicts an example system 100 that uses a specific method in order to filter content for an end-user for a specific context, based on personalized perspectives. The content is consumed by the user on an end-user device 102. The user's context can be created on the user's end-user device 102, made available by an end-user application server 110 or stored on a database associated with a content filtering/search server, such as content filtering/search server 106. As shown in FIG. 1, system 100 includes an end-user device 102, a network 104 (e.g., the World Wide Web or a corporate network) that enables users access to content available on content servers through software available on end-user devices, various content servers 108 (for example, Internet-based web servers, email servers, instant messaging servers, micro-blogging servers such as those used by Twitter® and social networks such as Facebook®), one or more content filtering/search servers 106, and various user application servers 110. End-user device 102 typically constitutes a single physical device (e.g., a cell phone 102D, a laptop computer 102C, a personal computer (PC) 102B, a personal digital assistant (PDA) 102A, a Netbook, or the like). Network 104 may comprise multiple servers and use various protocols (such as HTTP), allowing client software (a web browser, proprietary client or RSS reader) to access content made available on content servers 108, network elements (switches, routers, soft-switches), connectivity media (optical wiring, microwave point-to-point communications and such) and other components. User application servers 110 may include various servers, providing application services, interacting with client-side software running on end-user device 102, assisting in accessing, storing, caching, authenticating, verifying and organizing content served by content servers, with the end-user consuming the content on end-user device 102 through the client-side software.

End-user device 102 is capable of executing any of a variety of client-side software applications. Examples of such applications include web browsers (such as Internet Explorer®, published by Microsoft Corporation), an RSS reader, an SMS client, an instant messaging client, a social networking site, a micro-blogging reader/website or email client. As noted above, end-user device 102 may comprise a PC 102B, a laptop 102C, a PDA 102A, a cell phone 102C, or other device equipped with client-side software that enables it to consume relevant content.

End-user device 102, content servers 108, user application servers 110 and content filtering/search server(s) 106 may communicate with one another either directly or over network 104. Network 104 may be a publicly-accessible network or a proprietary, limited-access network and may comprise wired links, wireless links or a combination of wired and wireless links. Content servers 108, content filtering/search server(s) 106 and user application servers 110 may all be operated by a single business entity, or any one of them may be related to different business entities.

The work performed on content filtering/search server(s) 106 may result in creating a filtered/re-ranked list of content that is available on multiple content servers 108 and made available to end-user on end-user devices 102.

Operating together or separately, user application servers 110, end-user device 102 and content servers 108 may enable various applications such as email, SMS, RSS, web browsing or Internet search, allowing access to content that was filtered by content filtering/search server(s) 106.

It should also be apparent to persons skilled in the relevant art(s) that a plurality of content servers 108 can be part of the system, serving various forms of content (such as text, SMS, blog entries, wall posts, micro-blog posts, short-form videos and online articles, among others).

### B. Example System Architecture

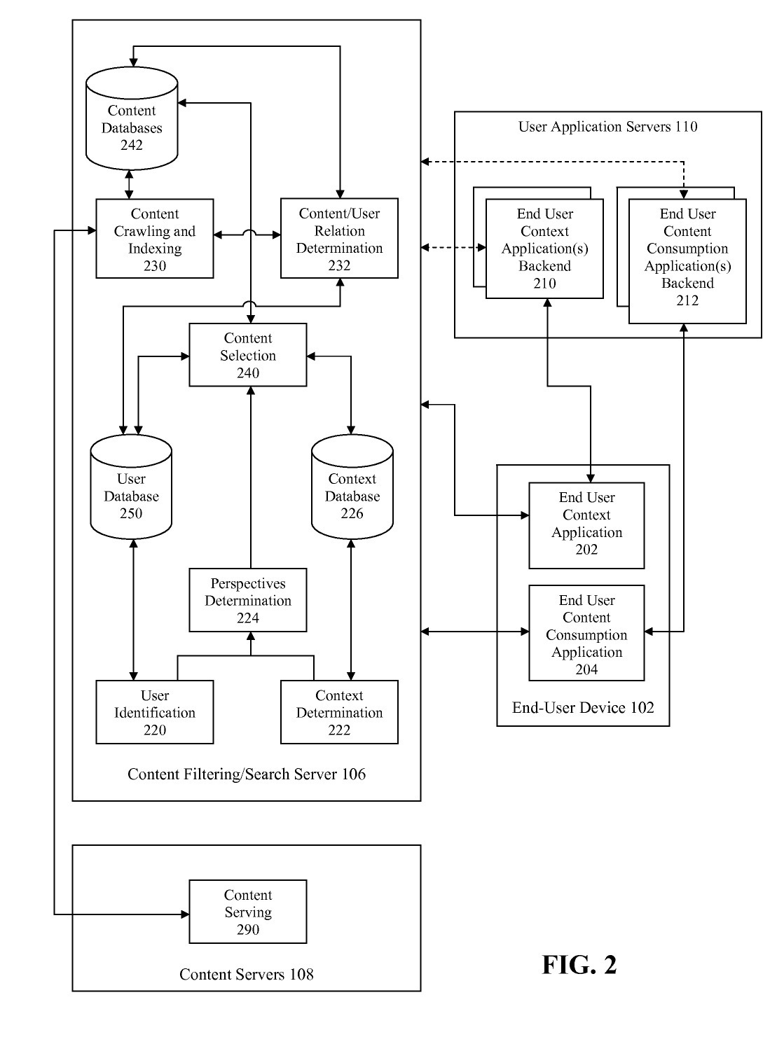

FIG. 2 is block diagram of an example system architecture that enables a perspective-based content filtering method in accordance with an embodiment.

As explained above, a user uses end-user device 102 in order to consume content. As used herein, the term “consuming content” includes but is not limited to viewing one or more of text, graphics and video content as well as listening to audio content. Consumption of content in various forms can be rendered in two steps—the definition of the content that we want to consume (the definition of the context of the desired content) and the actual consumption of that content. For example, web search can be seen to have two steps—the submission of a query that defines what the user is looking for and the rendering of the results inside a web browser that constitutes the end-user's consumption of the content. Another example may be the user's subscription to an RSS feed for specific types of content (definition of the context) where the user receives periodic alerts concerning new content that becomes available and can decide when to consume that content, consume older content once more, and so on. The method described herein is independent of whether the context definition is coupled with actual content consumption in either a temporal or applicative manner.

An end-user using end-user device 102 may initiate execution of a certain end-user context application 202. The execution of end-user context application 202 may be initiated explicitly in response to a user action and/or implicitly in response to an external event. End-user context application 202 may operate independently or rely on some interaction with end-user context application backend 210. Note that a single end-user device 102 may be capable of executing a plurality of end-user context applications 202, which in turn may interact with a plurality of end-user context application backends 210.

During the usage of application 202, a certain end-user context may be created. This end-user context may be created explicitly by the user and/or implicitly triggered by either an end-user action or through certain applicative logic. A typical end-user context may take various forms. One form might be a query to find content that matches certain parameters (such as a query to a search engine). Another form might be an explicit action by the user subscribing to a feed of content that relates to a specific interest area (whether ontologically defined or presented by free-form text definition). Yet another form may include additional information providing more data concerning the user (such as, but not limited to, environmental parameters such as the user's location, past behavior parameters that relate to, for example, interests of the user, information on the end-user context application the user is currently using, demographic information about the user, a list of identifiers (IDs) on various computing platforms and so on). Yet another form of end-user context may include a hierarchical structure of additional one or more end-user contexts, allowing a first user to receive collating, intersection or unifications of multiple end-user contexts, such end-user contexts being associated with the first user or with a group of one or more other users (e.g., friends of the first user).

The user context is delivered to content filtering/search server 106. At this point, content filtering/search server 106 tries to identify the user on whose behalf the context was provided. This function is performed by user identification component 220 and may be carried out, for example, using any of a variety of user identification methods known to persons skilled in the relevant art(s), such as but not limited to obtaining a cookie with a unique ID or username/password. Such user identification may comprise identifying the user based on personal identification information or identifying the user in an anonymous manner. If user identification component 220 identifies the user, the user's profile is retrieved from a user database 250. It should be noted that user database 250 may also serve as a proxy to external user databases, including databases that are part of end-user context application backend 210, end-user content consumption application backend 212, or part of content servers 108 applicative framework. For example, if the user has provided a Facebook® username to content filtering/search server 106, user database 250 may use various methods (including methods known to persons skilled in the relevant art(s), such as APIs and crawling) to retrieve the user profile from content servers 108 (in this case, the Facebook® web servers) in addition to any information held about the user in user database 250. If the user was not identified, a new user record will be created for the user in user database 250 and a unique ID assigned to him for later use.

Given the user context that the user provided, a context determination component 222 may try to align the context with any number of canonized contexts that may be stored in a context database 226. For example, if the user has provided a context in the form of a query, “tom yam soup,” context determination component 222, based on the use of semantic maps, synonym sets, statistical clustering algorithms, latent semantic indexing performed on content database 242 or other methods known to persons skilled in the relevant art(s), may determine a “canonical” context of “Thai Food.”

Given a user identity that was determined and/or created and/or enhanced by user identification component 220 and a user context, which was calculated by context determination component 222, based on the context provided by the end-user context application 202, a perspectives determination component 224 determines a plurality of matching perspectives for the user context that are specific to the user based on the user identification and profile information. The determination can be based on static information provided by the user (for example, the user may have configured context database 226 previously that when it comes to the search term “That Food,” he is interested in obtaining content related to chefs). In another embodiment, the determination of perspectives, given a user context, by perspective determination component 224 may be based on some other methods to associate a set of perspectives with the user context. A perspective includes a set of filters relating to attributes that content filtering/search server 106 manages for each user/person in user database 250. Various examples for a perspective can be “people living not more than ten miles from the user,” “chefs,” “chefs from New York City,” and “my friends” (assuming user database 250 is aware of friendship connections between users). It should be noted that such determination of perspectives may be specific to the user and may change from one user to another given the same context. In addition, it should be noted that such set of perspectives may correlate to perspectives associated with one or more specific users or groups of users, allowing the user to find information that is more relevant to a group of users (for example, if the user wishes to go out tonight with a group of his friends, he can obtain the set of perspectives and related content that are most relevant to the group in its entirety).

Content filtering/search server 106 also includes a content crawling and indexing engine 230. Content crawling and indexing engine 230 processes, synchronously to a user request or asynchronously, multiple content sources, interfacing, through means known to persons skilled in the relevant art(s), with many third-party content servers 108 through various content-serving elements 290. Various forms of content-serving elements may include web servers, APIs, email servers and databases, among others. Content crawling and indexing engine 230 may index all the content served by content servers 108 or a portion of it, depending upon the specific application and implementation of the invention.

Content filtering/search server 106 also includes a content/user relation determination component 232, which is responsible for assigning to each content item identified and indexed by content crawling and indexing engine 230 a set of users associated with it. In one embodiment, such assignments may be based on the determination of an authorship relationship between a user and a content item. In this case, the content item indexed will be associated with a record in user database 250 that identifies its author. The method of identifying users associated with the specific content item is implementation-specific and can vary from one content source to another. For example, if content server 108 is an email server, content/user relation determination component 232 may associate an indexed email message with the author of the message, while if content server 108 is a web server that was crawled by content crawling and indexing engine 230, the user associated with the content item may be the author of an indexed blog. In one embodiment, content filtering/search server 106 discards any content item that was crawled and/or indexed by content crawling and indexing engine 230 but that was not associated with any specific person by content/user relation determination component 232.

In a further embodiment, when a content item is indexed and multiple users are associated therewith, content filtering/search server 106 optionally tries to enhance information that it contains regarding users associated with the content, to be recorded in user database 250. In one implementation, content filtering/search server 106 may try to identify the associated user profile in various databases available in end-user context application(s) backend servers 210, end-user content consumption application(s) backend servers 212, content servers 108 or other third-party databases. For example, if a content item is an article published in a newspaper such as The New York Times and its author was identified as a person associated with the content item, content filtering/search server 106 may try to identify the author's profile on a social network such as Twitter® or Facebook® in order to add to the information available about that user.

When a set of personalized perspectives is determined to be relevant to an end-user and the determined end-user context and to a database of content in which content elements are attributed to certain people, content filtering/search server 106 can now filter the content and narrow it down to those content items that are associated with users that match the desired set of perspectives, given the user context.

Content scoring and ranking may be performed by content filtering/search server 106. Such scoring and ranking may be carried out in accordance with various methods known to persons skilled in the relevant art(s).

The filtered content, or pointers to such filtered content made available by content filtering/search server 106, is accessible through an API and can be consumed by an end-user content consumption application 204 or by end-user content consumption application backend 212. The consumption of the content can occur synchronously to the requests issued with the user context by end-user context application 202. In certain embodiments, content consumption can occur asynchronously. In other embodiments, content filtering/search server 106 can push content found, while in still other embodiments, content filtering/search server 106 responds with relevant content upon a request to pull filtered content by either end-user content consumption application 204 or by end-user content consumption application backend 212. In certain embodiments, content filtering/search server 106 can provide a one-time set of content items, while in other embodiments, such sets can be made available on a recurring basis.

### C. Example Process Flow

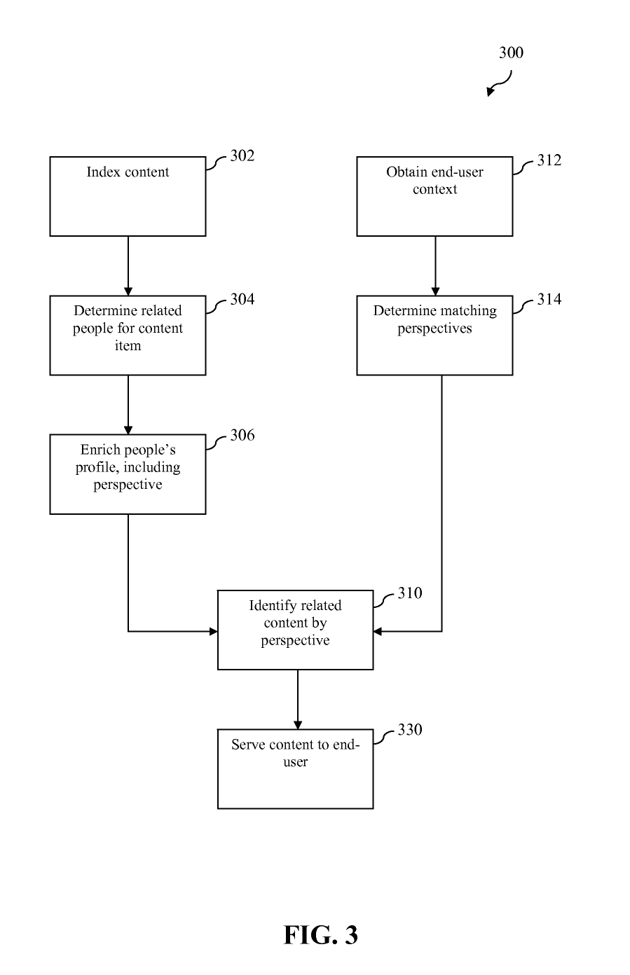

FIG. 3 depicts an example flowchart 300 of a method used to filter content for a user, based on perspectives, according to a user context in accordance with an embodiment. Although the method of flowchart 300 may be performed by system 100 described above in reference to FIG. 1 and the system components described above in reference to FIG. 2, persons skilled in the relevant art(s) will appreciate that the method of flowchart 300 may be performed by other systems and/or components as well.

In step 302, the system initiates crawling and indexing of a variety of content sources. As an alternative, the indexing of content can be triggered pursuant to a notification received by any external content database and source (e.g., receiving notifications through RSS feed or being called by an email server after a new email message has been received or sent via the email server). Content sources may include content servers 108, end-user application servers 110, or other sources. Indexing of the content item identified, sourced from various sources, may be performed in accordance with various methods known to persons skilled in the relevant art(s).

In step 304, a determination of people associated with the indexed content items is performed. Such determination may be performed by parsing structured information delivered with the content item. An example of such determination may be the extraction of the sender of an email message or the creator of a microblog post (such as a “tweet” in Twitter®), and determining that person to be associated with the content item. An alternative may be the determination of people associated with the indexed content item based on methods such as entity extraction. In accordance with such an approach, unstructured parts of the content item (e.g., the text of a newspaper article) are processed and various identification parameters (e.g., name, email address, social network profile ID) are extracted from the analysis. An example of this method is the determination of an author of a newspaper article based on a text analysis performed on the full text version of the article. Various techniques for performing entity extraction are known to persons skilled in the relevant art(s).

In step 306, after identifying the relevant people associated with a specific content item, the method adds additional information to the person's profile. In order to achieve that, the system may interface with multiple data sources. Some of the data sources may be structured—for example, databases associated with end-user context application 202 or with end-user content consumption application 204. One example of these may be corporate databases, including an employee database, that can be used to determine additional information such as department, position, colleagues and so on given a certain user ID, such as an email address. Other examples of structured information sources include social networks such as Facebook® and Twitter®, which may hold structured information associated with the user (e.g., the user's hometown). The system may also process unstructured information sources to enhance the profile of the user. For example, such information sources may include the content of email messages, wall posts on a social network, tweets in Twitter®, and so on. The system may then use various methods known to persons skilled in the relevant art(s) to derive related topics or attributes of a person. An example of this would be to use natural language processing to identify attributes. For example, if a user included the words “my kids” in his wall post, the system might deduce that the user was a parent. In another embodiment, the system might allow users to define their characteristics. In yet another embodiment, the system might suggest various characteristics that may be descriptive of the user and invite the user to agree or disagree with each of them.

In step 312, the system may receive a certain user context from the user. The context may be a specific ad-hoc query or structured information, such as a subject that interests the user. In this step, the system may process the given user context to match the user context with a canonical user context. Such matching may be performed using methods known to persons skilled in the relevant art(s), including synonym-based methods, relying on databases such as WordNet, natural language processing, and identifying a subject based on matching the user context with a cluster representing a subject, based on word frequencies.

In step 314, the system matches a user ID (which may also have been received in step 312) and the context that was obtained and further processed in step 312, to determine a plurality of perspectives that are relevant for this specific user and the specific context. In one embodiment, determination of such perspectives can be achieved by matching a subject and a user against a rule-based engine to determine the perspective. In another embodiment the system may allow the user to define the desired perspective for a specific context.

In step 320, the system uses the context and the plurality of the desired perspectives calculated in step 314 to filter the database of content items and rank the content items. Content delivered to the user follows the principle that the relevant people determined in step 304 match, in terms of their characteristics determined in step 306, the desired user-specific and content-specific perspective as determined in step 314. In one embodiment, the system may provide the user only with content that matches the calculated perspective. In another embodiment, the system may boost the rank of content that matches the perspectives over content that does not.

In step 330, the system serves content filtered and ranked in step 320 to the end-user. The serving may be performed using protocols and methods known to persons skilled in the relevant art(s). In one embodiment, serving may occur immediately upon such determination. In another embodiment, content may be stored in the system so that the user can “pull” it from content filtering/search server 106. The content is served and interfaced to by the user through end-user content consumption application 204 and/or by server-side logic and the application's processes, running on end-user content consumption application backend 212. In one embodiment, end-user context application 202 may be the same application as end-user content consumption application 204. In another embodiment, these two applications may be separate.

### D. Example Computer System Implementation

Any of the logical components included in end-user device 102, content filtering/search server(s) 106, content servers 108 and user application servers 110 may be implemented in hardware, software, firmware, or any combination thereof. For example, any of the logical components included in end-user device 102, content filtering/search server(s) 106, content servers 108 and user application servers 110 may be implemented as computer program code configured to be executed in one or more processors. Alternatively, any of the logical components included in end-user device 102, content filtering/search server(s) 106, content servers 108 and user application servers 110 may be implemented as hardware logic/electrical circuitry.

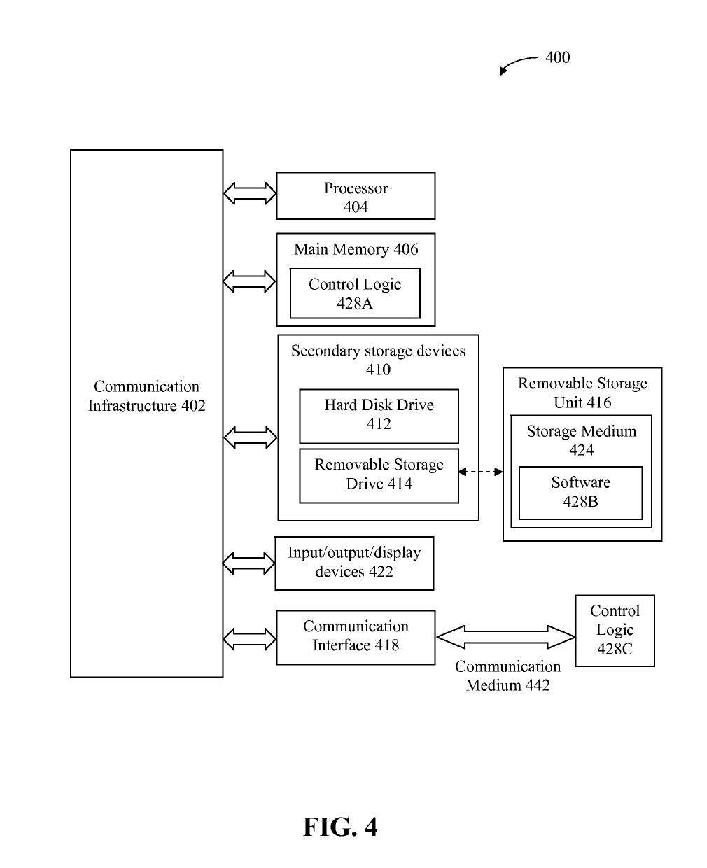

The embodiments described herein, including systems, methods/processes, and/or apparatuses, may be implemented using well known servers/computers, such as a computer 400 shown in FIG. 4. For example, any of the logical components included in end-user device 102, content filtering/search server(s) 106, content servers 108 and user application servers 110 may be implemented using one or more computers 400.

Computer 400 can be any commercially available and well known computer capable of performing the functions described herein, such as computers available from International Business Machines, Apple, Sun, HP, Dell, Cray, etc. Computer 400 may be any type of computer, including a desktop computer, a server, etc.

Computer 400 includes one or more processors (also called central processing units, or CPUs), such as a processor 404. Processor 404 is connected to a communication infrastructure 402, such as a communication bus. In some embodiments, processor 404 can simultaneously operate multiple computing threads.

Computer 400 also includes a primary or main memory 406, such as random access memory (RAM). Main memory 406 has stored therein control logic 428A (computer software), and data.

Computer 400 also includes one or more secondary storage devices 410. Secondary storage devices 410 include, for example, a hard disk drive 412 and/or a removable storage device or drive 414, as well as other types of storage devices, such as memory cards and memory sticks. For instance, computer 400 may include an industry standard interface, such a universal serial bus (USB) interface for interfacing with devices such as a memory stick. Removable storage drive 414 represents a floppy disk drive, a magnetic tape drive, a compact disk drive, an optical storage device, tape backup, etc.

Removable storage drive 414 interacts with a removable storage unit 416. Removable storage unit 416 includes a computer useable or readable storage medium 424 having stored therein computer software 428B (control logic) and/or data. Removable storage unit 416 represents a floppy disk, magnetic tape, compact disk, DVD, optical storage disk, or any other computer data storage device. Removable storage drive 414 reads from and/or writes to removable storage unit 416 in a well known manner.

Computer 400 also includes input/output/display devices 422, such as monitors, keyboards, pointing devices, etc.

Computer 400 further includes a communication or network interface 418. Communication interface 418 enables computer 400 to communicate with remote devices. For example, communication interface 418 allows computer 400 to communicate over communication networks or mediums 442 (representing a form of a computer useable or readable medium), such as LANs, WANs, the Internet, etc. Network interface 418 may interface with remote sites or networks via wired or wireless connections.

Control logic 428C may be transmitted to and from computer 400 via communication medium 442.

Any apparatus or manufacture comprising a computer useable or readable medium having control logic (software) stored therein is referred to herein as a computer program product or program storage device. This includes, but is not limited to, computer 400, main memory 406, secondary storage devices 410, and removable storage unit 416. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable storage devices. Examples of such computer-readable storage devices include a hard disk, a removable magnetic disk, a removable optical disk, flash memory cards, digital video disks, random access memories (RAMs), read only memories (ROM), and the like. As used herein, the term “computer-readable storage device” is used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other tangible media such as flash memory cards, digital video discs, RAM devices, ROM devices, and the like. Such computer-readable storage devices may store program modules that include computer program logic for implementing the features of end-user device 102, content filtering/search server 106, content servers 108, user application servers 110, and any of the sub-systems or components contained therein, any of the methods or steps of flowchart 300 of FIG. 3, and/or further embodiments of the present invention described herein. Embodiments of the invention are directed to computer program products comprising such logic (e.g., in the form of program code or software) stored on any computer useable storage device. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### E. Conclusion

While various embodiments of the present invention have been described above, it should be understood that they have been presented by way of example only and not limitation. It will be understood by those with the relevant skill(s) that various changes in form and details may be made therein without departing from the spirit and scope of the invention as defined in the appended claims. Accordingly, the breadth and scope of the present invention should not be limited by any of the above-described exemplary forms, but should be defined only in accordance with the following claims and their equivalents.

What is claimed is:

1. A method for filtering content for an end-user, comprising:
(a) performing a content discovery process that includes:
(i) indexing a plurality of content items;
(ii) identifying one or more people that are associated with each of the indexed content items; and
(iii) obtaining and storing information about the identified people associated with each of the indexed content items; and
(b) performing a content filtering process that includes:
(i) identifying an end-user or characteristics of the end-user;
(ii) receiving a user context generated by or on behalf of the end-user;
(iii) determining one or more perspectives based on the identified end-user or the identified end-user characteristics and the user context; and
(iv) filtering the indexed content items by matching the stored information about the identified people associated with each of the indexed content items to the determined one or more perspectives.

2. The method of claim 1, wherein the content items include both structured information and unstructured information.

3. The method of claim 1, wherein identifying the one or more people that are associated with each of the indexed content items comprises identifying an authorship relationship between a person and an indexed content item.

4. The method of claim 1, wherein identifying the end-user comprises identifying the end-user based on personal identification information or identifying the end-user in an anonymous manner.

5. The method of claim 1, wherein the user context may comprise one or more of:
a query;
one or more environmental parameters;
one or more past behavior parameters; or
one or more user contexts associated with the end-user or other users.

6. The method of claim 5, wherein the one or more environmental parameters comprise a location.

7. The method of claim 5, wherein the one or more past behavior parameters comprise information about interests of a user.

8. The method of claim 1, wherein determining the one or more perspectives based on the identified end-user or the identified end-user characteristics and the user context comprises using a rule-based engine or using a definition provided by the end-user.

9. The method of claim 1, wherein filtering the indexed content items includes at least one of excluding a non-matching indexed content item or boosting a rank associated with a matching indexed content item.

10. The method of claim 1, further comprising:
making the filtered content items available to the end-user.

11. The method of claim 10, wherein making the filtered content items available to the end-user comprises pushing the filtered content items to the end-user or storing the filtered content items so that the end-user can pull the filtered content items.

12. A content filtering system, comprising:
a content crawling and indexing component that is configured to index a plurality of content items;
a content/user relation determination component that is configured to identify one or more people that are associated with each of the indexed content items and to obtain and store information about the identified people associated with each of the indexed content items;
a user identification component that is configured to identify an end-user or characteristics of the end-user;
a context determination component that is configured to determine a user context associated with the user;
a perspectives determination component that is configured to determine one or more perspectives based on the identified end-user or the identified end-user characteristics and the determined user context; and
a content selection component that is configured to filter the indexed content items by matching the stored information about the identified people associated with each of the indexed content items to the determined one or more perspectives.

13. The system of claim 12, wherein the content items includes both structured information and unstructured information.

14. The system of claim 12, wherein the content/user relation determination component is configured to identify an authorship relationship between a person and an indexed content item.

15. The system of claim 12, wherein the user context may comprise one or more of:
a query;
one or more environmental parameters;
one or more past behavior parameters; or
one or more user contexts associated with the end-user or other users.

16. The system of claim 12, wherein the perspectives determination component is configured to use one or more of a rule-based engine or a definition provided by the end user to determine the one or more perspectives.

17. The system of claim 12, wherein the content selection component is configured to filter the indexed content by performing at least one of: excluding a non-matching indexed content item or boosting a rank associated with a matching indexed content item.

18. The system of claim 12, further comprising:
a content serving component that makes the filtered content items available to the end-user.

19. The system of claim 18, wherein the content serving component is configured to make the filtered content items available to the end-user comprises by performing at least one of: pushing the filtered content items to the end-user or storing the filtered content items so that the end-user can pull the filtered content items.

20. A method for filtering content for an end-user, comprising:
(a) identifying an end-user or characteristics of the end user;
(b) receiving a user context generated on or behalf of the end-user;
(c) determining one or more perspective based on the identified end-user or the identified end-user characteristics and the user context; and
(d) filtering indexed content items by matching stored information about people associated with each of the indexed content items to the determined one or more perspectives.
